(19) United States
(12) Patent Application Publication
(10) Pub. No.: US 2007/0218232 A1
(43) Pub. Date: Sep. 20, 2007

(54) Helical Support and Method for the Production Thereof

(76) Inventor: Thilo Simonsohn, Munchen (DE)

Correspondence Address: BARLEY SNYDER, LLC, 1000 WESTLAKES DRIVE, SUITE 275, BERWYN, PA, 19312, US

(21) Appl. No.: 11/683,044

(22) Filed: Mar. 7, 2007

(30) Foreign Application Priority Data
Mar. 16, 2006 (DE) 102006012593.2

(51) Int. Cl. B32B 37/00

(52) U.S. Cl. 428/36.9; 156/195; 156/272.8

(57) ABSTRACT

A helical support for radially supporting an elastically expanded insulating tube includes an extruded body consisting of a plurality of windings extending substantially parallel to each other. Each of the windings is at least partially connected at lateral edges thereof in a longitudinal direction of the helical support. The lateral edges are separably connected by at least one laser weld seam.

### CROSS-REFERENCE TO RELATED APPLICATIONS

This application claims the benefit of the filing date under 35 U.S.C. § 119(a)-(d) of German Patent No. DE 10 2006 012 593.2, filed Mar. 16, 2006.

### FIELD OF THE INVENTION

The invention relates to a helical support for radially supporting an elastically expanded insulating tube comprising an extruded body consisting of a plurality of windings extending substantially parallel to each other wherein each of the windings is at least partially connected at lateral edges thereof by at least one laser weld seam. The invention further relates a production device from making the helical support and a method for making the same.

### BACKGROUND

Helical supports are used to keep insulating tubes in an expanded state so that the insulating tubes can be assembled onto electrical components. The insulating tubes are used for electrical insulation or sealing of the electrical components in power engineering, such as, for example, cable couplings or cable plug-in connectors. Since high electrical voltages of over 100 kV, for example, may be applied to the electrical components, the insulating tubes are constructed with thick walls and made of materials with good electrical insulation properties, such as silicone. In the assembled state, the insulating tube should match the outer contour of the electrical component to eliminate any gaps there between. The insulating tube is therefore resiliently expanded in diameter by approximately three to four times before assembly. This makes it easy to insert the electrical components into the insulating tube.

In order to keep the insulating tube in the expanded state until it is assembled onto the electrical component, the helical support is inserted into the insulating tube. The helical support is configured to absorb the restoring force caused by the resilient expansion of the insulating tube. For assembly, the electrical component to be insulated is positioned inside the helical support. The helical support is then removed from the insulating tube, so that the insulating tube can contract around the electrical component thereby sealing and insulating the electrical component.

The helical support can be manually removed from the insulating tube even under pressure forces of approximately 10 bar. The helical support can be gradually released by unwinding the extruded body. The extruded body is unwound by pulling on one free end of the extruded body which extends through the helical support. As the helical support is gradually unwound, the insulating tube automatically contracts around the electrical component. In this way, the helical support can be manually removed from the insulating tube without further aids or devices.

The helical support therefore must be able to permanently withstand the pressure acting on it from the expanded insulting tube and be manually removable from the insulating tube. It is further important that sufficient space is available inside the helical support for inserting the electrical components, for example, by way of a small wall thickness. In order to ensure these properties, the edges of the windings are welded together, for example, by heating in an oven or by ultrasonic welding. Alternatively or additionally, the edges may be shaped in such a way that they mechanically lock with one another. Helical supports of this type are described, for example, in U.S. Pat. No. 5,087,492, EP 0 619 636 A1, WO 93/22816, WO 83/00779, DE 198 20 634 C1, EP 0 399 263 A2, U.S. Pat. No. 5,670,223 or WO 96/24977.

In the above-described helical supports, however, there is a problem in that either the connection between the individual windings is structurally complicated and cost-intensive and/or the edges are unevenly firmly connected to one another. Uneven connection of the edges can cause the necessary release forces necessary for manual unwinding of the extruded body to fluctuate greatly. Thus, separation of the connected edges when the helical support is released can be more difficult, can be manually impossible, and/or can cause the windings to break.

### BRIEF SUMMARY

It is therefore the object of the invention to provide a helical support that can be produced at a reasonable price, that can reliably withstand outside radial pressure forces, and that can easily be manually removed from an insulating tube.

This and other objects are achieved by a helical support for radially supporting an elastically expanded insulating tube comprising an extruded body consisting of a plurality of windings extending substantially parallel to each other. Each of the windings is at least partially connected at lateral edges thereof in a longitudinal direction of the helical support. The lateral edges are connected by at least one laser weld seam.

This and other objects are further achieved by a production device for producing a helical support for radially supporting an elastically expanded insulating tube comprising a holding device having an outer circumferential face for receiving an extruded body. The holding device is rotatable about a longitudinal axis thereof. At least one pressure roller is positioned adjacent to the holding device for receiving the extruded body there between. The pressure roller exerts pressure on the outer circumferential face of the holding device. A laser welding device is moveable relative to the holding device.

This and other objects are still further achieved by a method for producing a helical support for radially supporting an elastically expanded insulating tube, comprising: winding a plurality of windings from an extruded body substantially parallel to each other to form the helical support; and welding lateral edges of the adjacent windings at least partially to each other along a longitudinal direction of the helical support with laser light to form a laser weld seam.

### BRIEF DESCRIPTION OF THE DRAWINGS

FIG. 1 is a schematic illustration a helical support according to an embodiment of the invention.

FIG. 2 is a schematic sectional illustration of detail A from FIG. 1.

FIG. 3 is a schematic sectional illustration of an alternative embodiment of detail A from FIG. 1.

FIG. 4 is a schematic illustration of an alternate embodiment of a weld seam of detail B from FIG. 1.

FIG. 5 is another alternative embodiment of the weld seam of detail B from FIG. 1.

FIG. 6 is a further alternative embodiment of the weld seam of detail B from FIG. 1.

FIG. 7 is a schematic illustration of a device according to the invention for producing the helical support.

FIG. 8 is a schematic illustration of a tube arrangement according to the invention shown with the helical support from FIG. 1.

FIG. 9 is a schematic sectional illustration of an extruded body from FIG. 2.

FIG. 10 is a schematic sectional illustration of an alternative embodiment of the extruded body from FIG. 2.

FIG. 11 is a schematic sectional illustration of another alternative embodiment of the extruded body from FIG. 2.

### DETAILED DESCRIPTION OF THE EMBODIMENT(S)

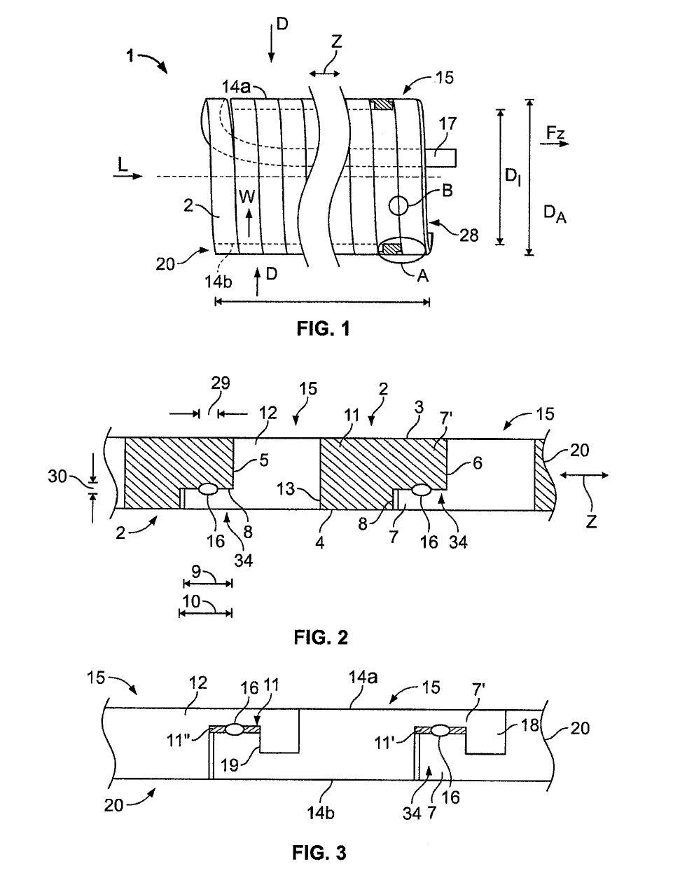

FIG. 1 shows a helical support 1 according to an embodiment of the invention. The helical support 1 is a substantially tubular body that extends in a longitudinal direction L and has a substantially circular cross-section. Alternatively, the helical support 1 may be constructed to have, for example, an oval or square cross-section. As shown in FIG. 1, the helical support 1 comprises an extruded body 2. The extruded body 2 may be produced, for example, from any known extrusion method, such as co-extrusion or multi-layer extrusion, and may be formed from any flexible, rigid material, such as a plastic material. The extruded body 2 may be formed of a solid material or may be constructed to be substantially hollow in cross-section cross-section, in order to reduce the amount of material and the weight of the helical support 1.

The extruded body 2 consists of a plurality of winding 15 wound substantially in a winding direction W. The extruded body 2 is therefore a substantially continuous ribbon body. Because the extruded body 2 is formed as a substantially continuous ribbon body, the extruded body 2 can form the helical support 1 to any desired length. The helical support 1 is generally approximately 30-50 cm long. The helical support 1 has an outer diameter DA and an inner diameter D1.

As shown in FIGS. 2 and 9, each of the windings 15 of the extruded body 2 has a substantially rectangular cross-section consisting of substantially parallel upper and lower edges 3, 4 and shorter lateral edges 5, 6. The lateral edge 6 is formed to have a substantially rectangular projection 7 and a substantially rectangular recess 8′ formed at a substantially right angle with respect to each other. The lateral edge 5 is formed to have a substantially rectangular recess 8 and a substantially rectangular projection 7′ formed at a substantially right angle with respect to each other. The projection 7 and the recess 8′ are configured such that the projection 7 and the recess 8′ of the winding 15 mate with the recess 8 and the projection 7′ of the adjacent winding 15 when the extruded body 2 is wound to form the helical support 1. The lateral edges 5, 6 of the adjacent windings 15 are thereby mechanically connected to each other.

As shown in FIGS. 2 and 9, each of the windings 15 has a melting portion 1I1 (illustrated as a shaded region in FIGS. 2 and 9) and a transparent portion 12. The transparent portion 12 is constructed of a material that is transparent, for example, to laser light. The transparent portion 12 therefore does not heat up when irradiated with laser light and conducts the laser light. The melting portion 11 is constructed of a material that absorbs, for example, laser light. The melting portion 11 therefore heats-up when exposed to the laser light and is thus capable of melting when irradiated with laser light. The melting portion 11 may be enhanced with an absorbent material, such as pigments, glass fibers, or other filling materials, such as mica or chalk. A separating edge 13 extends between the melting portion 1 1 and the transparent portion 12. The separating edge 13 extends substantially perpendicular to the upper and lower edges 3, 4. In the illustrated embodiment, the lateral edge 5 is constructed in the melting portion 11 and the lateral edge 6 is constructed in the transparent portion 12, however, the lateral edge 6 may alternatively be constructed in the melting portion 11 and the lateral edge 5 may alternatively be constructed in the transparent portion 12.

As shown in FIGS. 1-2, the upper edges 3 of the windings 15 form an outer circumferential face 14a of the helical support 1 and the lower edges 4 of the windings 15 form an inner circumferential face 14b of the helical support 1. The windings 15 are wound in such a way that the lateral edges 5, 6 mate with the lateral edges 5, 6 of the adjacent windings 15. Because the projections 7 of the windings 15 engage in the recesses 8 of the adjacent windings 15 in each case, the adjacent windings 15 substantially overlap with one another. Additionally, the melting portion 11 of each of the windings 15 is surrounded in a region of the projection 8 in a radial direction by the transparent portion 12 of the adjacent winding 15.

As shown in FIG. 2, a laser weld seam 16 connects the lateral edges 5, 6 of the adjacent windings 15 by firm bonding. In FIG. 2, the laser weld seam 16 connects the projection 7 of the winding 15 to the projection 7′ of the adjacent winding 15. The laser weld seam 16 is constructed with a weld seam width 29 and a weld seam depth 30. The laser weld seam 16 is inside a wall 20 of the helical support 1, between the outer circumferential face 14a and the inner circumferential face 14b. In order to be able to construct the laser weld seam 16 inside the wall 20 of the helical support 1, the laser weld seam 16 must be optically accessible to a laser beam from an outside thereof. This optical accessibility is guaranteed by the transparent portions 12. The laser weld seam 16 further forms a weakened region 34 in the helical support 1, at which the lateral edges 5, 6 are separably connected to one another. In other words, at the weakened region 34, the laser weld seam 16 has a lower resistance than at other areas. Alternatively, ultrasound could be used for welding or pre-heating the extruded body 2 in addition to the laser light.

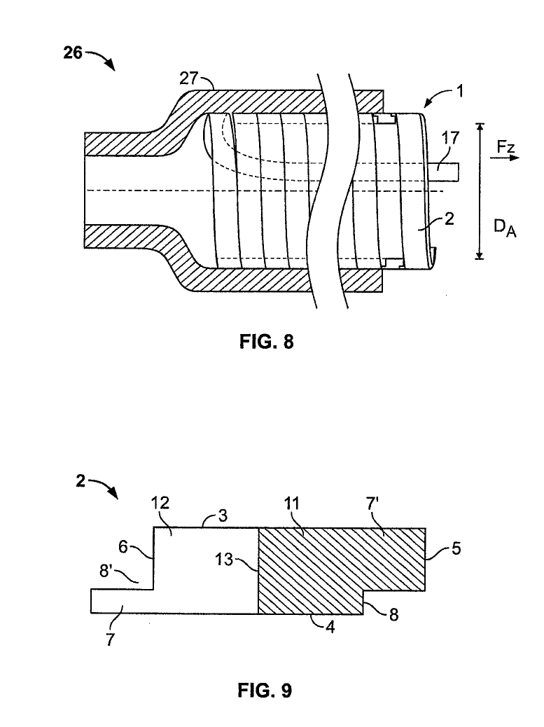

FIG. 8 shows a tube arrangement 26 wherein the helical support 1 is inserted into an insulating tube 27. The insulating tube 27 may be formed, for example, of a resiliently expanded electrically insulating material, such as silicon or other materials used to electrically insulate electrical components in the manner of a shrink tube. As shown in FIG. 8, the helical support 1 is inserted into the insulating tube 27 such that the insulating tube 27 is held in an expanded state by the helical support 1. While the insulating tube 27 is held in the expanded state by the helical support 1, the insulating tube 27 is positioned about an electrical component (not shown).

In order to release or dismantle the helical support 1, the extruded body 2 is unwound or unwrapped by pulling on a free end 17 of the extruded body 2 with a release force FZ, as shown in FIG. 1. The free end 17 is pulled out in a longitudinal direction L through an interior 28 of the helical support 1. As the free end 17 is pulled, the lateral edges 5, 6 are separated in the weakened region 34 and released from one another. The release force FZ must be at least large enough for the reduced resistance to be overcome in the respective weakened region 34 and for the lateral edges 5, 6 to separate. The shape of the extruded body 2 is substantially retained after tearing. In order to support the tearing-off in the weakened region 34, the extruded body 2 is made of the substantially stiff material, at least in the region round the laser weld seam 16. Because of the stiff material, a peeling effect is supported during unwinding of the helical support 1 and deformation with tensile or shear stressing of the weld seam 16 is prevented. As soon as the helical support 1 is removed, the expanded insulating tube 26 relaxes and contracts about the electrical component (not shown).

As the laser weld seam 16 is made with precisely predetermined and particularly even dimensions 29, 30, the helical support 1 according to the invention reliably withstands pressure forces D acting inwards in a radial direction and tensile forces acting in the pulling direction Z. Additionally, the pressure resistance of the helical support 1 is reinforced by the laser weld seam 16 of the windings 15, which overlap with the projections 7, 7′ in the radial direction and support one another. Further, the helical support 1 is not over-dimensioned, because of the exact construction of the laser weld seam 16. By laser welding, the resistance in the weakened region 34 can be very precisely predetermined, so it is large enough to be able to withstand pressure forces D and tensile forces acting in the pulling direction Z acting from outside, but small enough to be able to separate the lateral edges 5, 6 manually.

FIG. 3 shows an alternative embodiment of the extruded body 2. As shown in FIG. 3, the projections 7, 7′ are constructed at substantially right angles with respect to each other. Each of the projections 7, 7′ has a holding face 19, 18, respectively. The holding face 18 is aligned substantially transversely to a longitudinal direction of the holding face 19. When the extruded body 2 is wound to form the helical support 1, the projections 7, 7′ engage in one another such that the holding face 18 is supported on the holding face 19 with tensile forces acting in the pulling direction Z. The adjacent windings 15 are thereby locked in the pulling direction Z by the crimped projections 7, 7′ engaging in one another.

Additionally, in the alternative embodiment shown in FIG. 3, the extruded body 2 is entirely formed of the transparent portion 12. The transparent portion 12 may be, for example, a laser transparent plastic material. The melting portion 11 is formed by providing the windings 15 with an absorbent layer 11′ formed, for example, of an absorbent material. The absorbent layer 11′ may be applied to the windings 15, for example, by painting, spraying, dip coating, or co-extrusion. Alternatively, the melting portion 11 may be formed by providing the windings 15 with a ribbon material 11″. The ribbon material 11″ may be placed, for example, between the adjacent windings 15 of the extruded body 2 during winding. The laser weld seam 16 is inside the wall 20 of the helical support 1, between the outer circumferential face 14a and the inner circumferential face 14b. Optical accessibility to the inside of the wall 20 of the helical support 1 is guaranteed by the transparent portion 12.

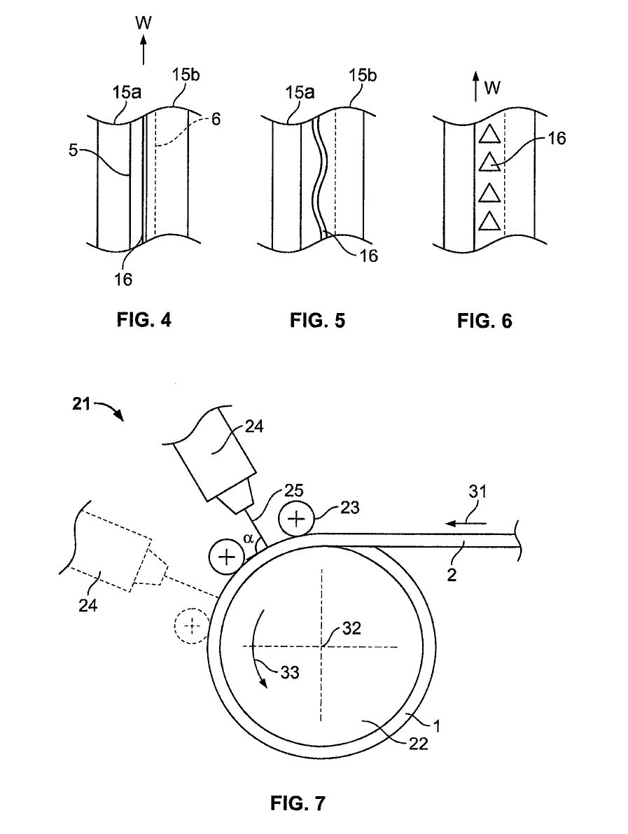

FIG. 4 shows an alternate embodiment of the laser weld seam 16. As shown in FIG. 4, the helical support 1 comprises the adjacent windings 15a, 15b. The winding 15b substantially overlaps the winding 15a in a horizontal direction. In the embodiment shown in FIG. 4, the laser weld seam 16 is constructed as a line extending substantially parallel to the winding direction W and substantially parallel to the lateral edges 5, 6. Alternatively, the windings 15a, 15b may be connected by a plurality of substantially parallel laser weld seams 16.

FIG. 5 shows another alternate embodiment of the laser weld seam 16. As shown in FIG. 5, the adjacent windings 15a, 15b are connected to one another by a plurality of laser weld seams 16 extending in a horizontal direction. The laser weld seams 16 have a substantially wave shape.

FIG. 6 shows a further alternate embodiment of the laser weld seam 16. As shown in FIG. 6, the laser weld seam 16 connects the lateral edges 5, 6 only at points or in portions to form a spot seam. For example, the laser weld seam 16 may be constructed as a plurality of triangles or as a broken line. Alternatively, the laser weld seam 16 may be constructed as other geometric shapes, such as diamonds, parallelograms, etc. Because the laser weld seam 16 connects the lateral edges 5, 6 only at points or in portions, the lateral edges 5, 6 can be easily separated by the release force FZ. For example, the lateral edges 5, 6 are connected less firmly at a tip of the triangles, owing to the smaller welding face.

FIG. 7 shows a production device 21 for the helical support 1 according to an embodiment of the invention. As shown in FIG. 7, the production device 21 comprises a substantially cylindrical holding device 22, a plurality of pressure rollers 23, and at least one laser welding device 24. The holding device 22 may be constructed, for example, as a mandrel. During production of the helical support 1, the extruded body 2 is clamped into the holding device 22. The extruded body 2, in a freshly extruded state, is fed into the production device 21 in a feed direction 31. The holding device 22 turns about a longitudinal axis 32 in a direction of rotation 33. The holding device 22 subsequently winds up the extruded body 2 an outer circumferential face of the holding device 22 in such a way that the adjacent windings 15 substantially touch one another and substantially overlap in a radial direction. As the extruded body 2 is fed into the production device 21, the plurality of pressure rollers 23 press the extruded body 2 against the outer circumferential face of the holding device 22, so that the inner and outer diameters D1, DA of the resulting helical support 1 are constant.

The lateral edges 5, 6 of the extruded body 2 are welded by a laser beam 25 generated by the statically arranged laser welding device 24. In order to generate a plurality of the laser weld seams 16 in the helical support 1, the production device 21 may have more than one of the laser welding devices 24 (as shown in FIG. 7 by broken lines). The laser welding device 24 is arranged at a radial distance from the holding device 22, and the laser beam 25 consisting of focused laser light impinges on the helical support 1 from an outside thereof. Alternatively, the laser welding device 24 may be arranged inside the holding device 22 or the laser beam 25 may be diverted via a mirror (not shown) to an inside of the helical support 1. During laser welding the welding energy is well metered and particularly precisely guided, so energy losses are avoided and the laser weld seam 16 arises at the predetermined connecting point with precise dimensions. In order to produce the helical support with particularly little time expenditure, the edges may be welded in one operating step during winding.

Because of the course of the laser weld seam 16 of the two portions in respect to one another, it is possible to determine structurally at what depth inside the wall 20 of the helical support 1 the laser weld seam 16 forms during welding. During welding, the laser beam 25 penetrates the material of the transparent portion 12, which is transparent to laser light, without appreciable effect and the laser weld seam 16 arises where the laser beam 25 impinges on the melting portion 11. The melting portion 11 is melted by the laser beam 25 consisting of the focused laser light. The transparent portion 12 adjacent to the melting portion 11 is heated and welded only indirectly by the heated melting portion 12, but not directly by the laser light.

The laser beam 25 is incident on the extruded body 2 of the helical support 1 at an angle a. In the illustrated embodiment, the angle a is constructed as being substantially rectangular. The width 29 of the laser weld seam 16 may be influenced by the angle a and/or a diameter of the laser beam 25. The depth 30 of the laser weld seam 16 is substantially determined by the intensity of the laser beam 25 and/or the feed rate and the rotational speed of the holding device 22. To support the laser weld seam 16, the lateral edges 5, 6 may additionally be glued together or mechanically locked, so the stability of the helical support 1 is increased. To support the laser beam 25, ultrasound may also be introduced into the extruded body 2.

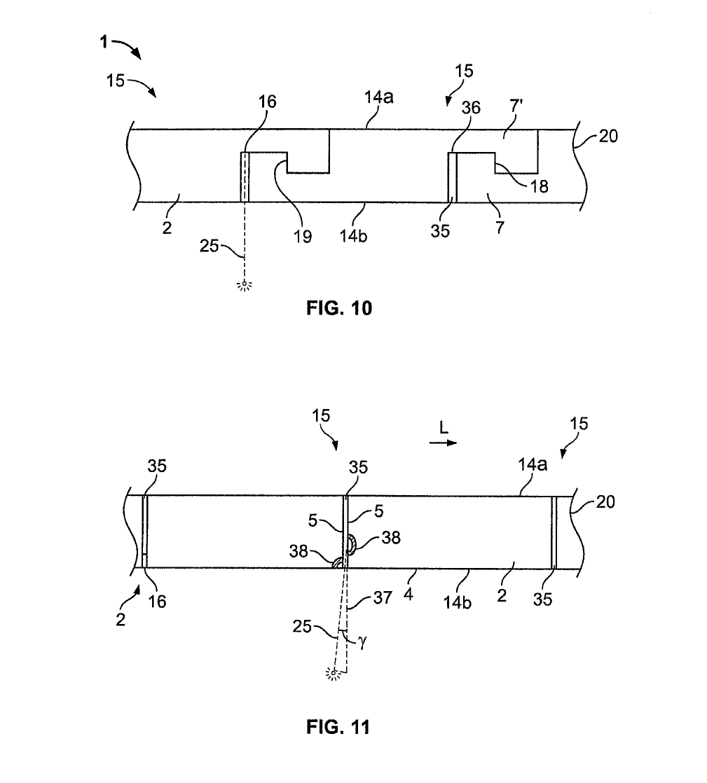

FIG. 10 shows another embodiment of the extruded body 2. As shown in FIG. 10, the welding can take place through a winding gap 35 between the adjacent windings 15. On the left of the winding 15, the weld seam 16 is being made with the laser beam 25, and on the right of the winding 15, the weld seam 16 has not yet been made. The laser beam 25 is substantially parallel to the wall of the winding gap 35 and is directed at a base 36 thereof, so that the laser weld seam 16 is formed on the base 36 of the winding gap 35. This configuration has the advantage in that there is no need for the transparent portion 12. As with the above embodiments, however, the point at which the laser beam 25 impinges must be made of a laser-absorbent material. As with the above embodiments, this can be done by appropriately coating the windings 15 in a region of the base 36. In a simplified configuration, however, the entire extruded body 2 can be made of a laser-absorbent material.

FIG. 11 shows a further embodiment of the extruded body 2. As shown in FIG. 11, the extruded body 2 is formed without the projections 7, 7′. The winding gap 35 extends through the entire thickness of the extruded body 2 from the outer circumferential face 14a to the inner circumferential face 14b. The adjacent windings 15 are butt-welded together. In order to weld the adjacent windings 15, the laser beam 25 is inclined with respect to a longitudinal direction 37 of the winding gap 35 about an angle y such that the winding gap 35 impinges on one of the lateral edges 5 of the extruded body 2. The lateral edges 5 are thereby melted onto each other. The angle γ of the laser beam 25 can also be set in such a way that the laser beam 25 impinges on both of the adjacent windings 15 such that a melting zone 38 leads to the melting of the material on the both of the lateral edges 5. As shown on the left in FIG. 11, the material then shrinks and forms the weld seam 16 by bridging the winding gap 35.

The winding gap 35 does not have to extend substantially transversely to the longitudinal direction L of the winding gap 35, but can also be inclined against the longitudinal direction L, as long as the laser beam 25 is inclined about an angle γ. Additionally, it is possible to dispense with the inclination of the laser beam 25, if the winding gap 35 has a substantially V-shaped cross-section and the two lateral edges 5 of the extruded body 2 touch one another at the base 36 of the winding gap 35. Further, it is possible for only the region on which the laser beam 25 impinges to be made of a laser-absorbent material or for the entire extruded body 2 to be made of a laser-absorbent material.

In the helical support 1 according to the invention, over-heating of the helical support 1 in portions at a distance from the laser weld seam 16, as occurs, for example, with the ultrasound welding practiced to date that can lead to undesired changes in material and bonds, is ruled out with laser welding by laser light focused precisely on the target. The quality of the weld connection is considerably improved by the laser welding according to the invention compared with the known helical supports. Furthermore, the construction of the laser weld seam 16 is simple in terms of manufacturing technology, so the helical support 1 according to the invention can be produced at a reasonable price.

The laser weld seam 16 can further be constructed between the outer circumferential face 14a and the inner circumferential face 14b of the helical support 1. Therefore, both the inner circumferential face 14b and the outer circumferential face 14a are substantially uninfluenced by the laser welding. In this way the outer circumferential face 14a and the inner circumferential face 14b are constructed with a particularly smooth surface, so neither the pulling of the insulating tube 27 onto the outer circumferential face 14a, nor the insertion of the electrical component (not shown) into the inside of the helical support 1 are impeded by a changed surface.

The foregoing illustrates some of the possibilities for practicing the invention. Many other embodiments are possible within the scope and spirit of the invention. It is, therefore, intended that the foregoing description be regarded as illustrative rather than limiting, and that the scope of the invention is given by the appended claims together with their full range of equivalents.

What is claimed is:

1. A helical support for radially supporting an elastically expanded insulating tube, comprising:
an extruded body consisting of a plurality of windings extending substantially parallel to each other, each of the windings being at least partially connected at lateral edges thereof in a longitudinal direction of the helical support, the lateral edges being connected by at least one laser weld seam.

2. The helical support of claim 1, wherein the lateral edges have projections that mate with recesses in the lateral edges of the adjacent windings.

3. The helical support of claim 1, wherein the windings substantially overlap in the longitudinal direction.

4. The helical support of claim 1, wherein at least one lateral edge of each of the windings is provided with a transparent portion, the transparent portion being transparent to laser light.

5. The helical support of claim 4, wherein at least one lateral edge of each of the windings is provided with a melting portion, the melting portion being capable of absorbing laser light.

6. The helical support of claim 5, wherein the melting portion is enhanced with pigment, glass fibers, mica, or chalk.

7. The helical support of claim 5, wherein the transparent portion at least partially overlaps the melting portion.

8. The helical support of claim 7, wherein the laser weld seam is formed where the transparent portion at least partially overlaps the melting portion.

9. The helical support of claim 1, wherein the lateral edges are separable from each other at the laser weld seam.

10. The helical support of claim 1, wherein the laser weld seam is between an inner circumferential surface and an outer circumferential surface of the helical support.

11. The helical support of claim 1, wherein the laser weld seam bridges a winding gap between the adjacent windings.

12. A production device for producing a helical support for radially supporting an elastically expanded insulating tube, comprising:
a holding device having an outer circumferential face for receiving an extruded body, the holding device being rotatable about a longitudinal axis thereof;
at least one pressure roller positioned adjacent to the holding device for receiving the extruded body there between, the pressure roller exerting pressure on the outer circumferential face of the holding device; and
a laser welding device moveable relative to the holding device.

13. A method for producing a helical support for radially supporting an elastically expanded insulating tube, comprising:
winding a plurality of windings from an extruded body substantially parallel to each other to form the helical support; and
welding lateral edges of the adjacent windings at least partially to each other along a longitudinal direction of the helical support with laser light to form a laser weld seam.

14. The method of claim 13, wherein the lateral edges are welded as the plurality of edges are wound.

15. The method of claim 13, wherein the windings are seperable from one another at the laser weld seam.

16. The method of claim 13, further comprising introducing ultrasound into the windings.

17. The method of claim 13, further comprising at least partially gluing or mechanically securing the lateral edges to each other.

18. The method of claim 13, wherein the laser weld seam is formed between an inner circumferential surface and an outer circumferential surface of the helical support.

19. The method of claim 13, wherein the laser weld seam bridges a winding gap between the adjacent windings.

20. The method of claim 13, wherein, at least one lateral edge of each of the windings is provided with a transparent portion, the transparent portion being transparent to laser light.

21. The method of claim 20, wherein at least one lateral edge of each of the windings is provided with a melting portion, the melting portion being capable of absorbing laser light.

22. The method of claim 21, wherein the transparent portion at least partially overlaps the melting portion.

23. The method of claim 22, wherein the laser weld seam is formed where the transparent portion at least partially overlaps the melting portion.
